(19) United States
(12) Patent Application Publication
(10) Pub. No.: US 2014/0289089 A1
(43) Pub. Date: Sep. 25, 2014

(54) SYSTEMS AND METHODS FOR DELIVERING TRADE AGREEMENT PERFORMANCE

(71) Applicant: ULTIMATE FOODSPEND SOLUTIONS, LLC, Joliet, IL (US)

(72) Inventor: Thomas C. STEWART, JR., Joliet, IL (US)

(73) Assignee: ULTIMATE FOODSPEND SOLUTIONS, LLC, Joliet, IL (US)

(21) Appl. No.: 14/211,306

(22) Filed: Mar. 14, 2014

Related U.S. Application Data
(60) Provisional application No. 61/783,654, filed on Mar. 14, 2013.

(51) Int. Cl. G06Q 40/04

(52) U.S. Cl. CPC G06Q 40/04
USPC 705/37

(57) ABSTRACT

Systems and methods for the inception, management and settlement of trade agreements are provided. The technology network platform provides for the effective delivery of all key requirements in the complete life cycle of foodservice trade agreements in one standardized system. The network will provide process discipline from inception to settlement replacing thousands of activities currently undertaken independently by foodservice supply chain participants.

### CROSS REFERENCE TO RELATED APPLICATION

This application claims priority under 35 U.S.C. §120 to U.S. Provisional Application No. 61/783,654, filed Mar. 14, 2013, the entirety of which is incorporated herein by reference.

### TECHNICAL FIELD

Embodiments disclosed herein are related to systems and methods for a technology platform for trade agreement life cycle management between and among participants in a supply chain.

### BACKGROUND

Within the food service industry, there are two basic types of trade agreements between buyers and sellers. Distribution agreements that structure terms and conditions for delivery of products to foodservice operating facilities, and trade-spend agreements that provide competitive pricing to foodservice operating entities via discounted pricing and/or rebates. Within the food service supply chain, there are two prevalent types of trade agreements among Operators, Distributors and Manufacturers (throughout this disclosure the term “Manufacturers” is used to mean all vendor types including service providers, e.g. a telephone carrier): Distribution agreements between Operators and Distributors and Trade-spend agreements between Manufacturers and Operators and/or Distributors. The former agreement type is put in place to assure delivery of products to an Operator's facilities; the latter agreement type is put in place to provide competitively priced products.

The placement and application of both, but particularly of food service trade-spend agreements is complicated, slow and costly for all concerned. Efforts to bring clarity and standardization to the management of such agreements are largely localized in nature (purchased back office software applications, for example) that do not enable the ability to provide global industry wide governance improvement. Various organizations have endeavored to offer services for managing trade agreements for the food service industry including ITradenetwork®, which is a consolidation of a number of early foodservice business to business providers. There are also other providers of some scale like SAP® who work through third party providers like Vistex® and focus on providing software to track rebates and market profitability analyses through consulting services and the like; each of these providers focus upon specific elements of selling, general and administrative expenses specific only to an individual client. There are a number of other smaller trade specific providers of tracking and monitoring services such as Blacksmith®, AFS Technologies®, and Tibersoft® that are in the space.

Heretofore, managing these agreements has been accomplished individually by each trading party creating added supply chain cost and complexity.

### SUMMARY

Disclosed embodiments provide systems and methods that utilize a technology platform that enables trade agreement life cycle management between and among participants in a supply chain.

In accordance with at least one disclosed embodiment, there is provided, at the core of the technology platform, a data warehouse and database management platform. Database elements stored and managed by the platform include trade agreements, trade agreement stakeholders (e.g., suppliers, products, distributors, and end users). Data may be sourced from transactions within the supply chain and from industry third party aggregating sources. Data synchronization and standardization processes become established standards.

In accordance with at least one disclosed embodiment, trade agreements may be loaded via an online negotiation/planning application or directly from supply chain trading parties. In each case, an agreement may be homogenized to meet established standards allowing for complete synchronization with all of the ensuing management actions to follow.

### BRIEF DESCRIPTION OF THE FIGURES

FIG. 1 is block diagram illustrating one embodiment of the technology platform including basic functional elements.

FIG. 2 is a more detailed diagram of the features illustrated in FIG. 1 and showing primary management and measurement functions of the technology platform provided in accordance with the disclosed embodiments.

FIG. 3 is a figure illustrating the trade agreement lifecycle model with accompanying technology platform touchpoints.

FIG. 4 illustrates a high-level overview of the platform architecture, administration, function and web portal accessibility of various users.

FIG. 5 is a figure illustrating onboarding and synchronization of client and industry sourced data and trade agreements consistent with at least one embodiment.

FIG. 6 is a figure illustrating the online negotiation/planning embodiment between buyer and seller.

FIG. 7 is a figure illustrating the active monitoring of trade agreement performance in accordance with the disclosed embodiments.

FIG. 8 is a figure illustrating the active promotion of trade agreements and solicitation of increased compliance and/or new trade agreement customers.

FIG. 9 is a figure illustrating the adjudication and financial settlement of trade agreements.

FIG. 10 is a figure illustrating the use of the Mobile Application via a mobile device.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Moreover, it should be understood that various connections are set forth between elements in the following description; however, these connections in general, and, unless otherwise specified, may be either direct or indirect, either permanent or transitory, and either dedicated or shared, and that this specification is not intended to be limiting in the respect.

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

In 2012, there was an estimated $165 billion in revenue across all trade channels (e.g., healthcare, fast food, lodging, higher education, K-12 schools, etc.) in contracted trade-spend agreements alone. Recent studies have verified that manufacturers spent 18% of that number or $29 billion in trade-spend program payments and discounts. Of that $29 billion, a good portion typically is “paid twice” meaning that manufacturers pay an allowance or provide a discounted price for the same sales transaction through two or more trade-spend programs. For example, recently, a state school consortium received over $2 million in duplicated allowance payments over, for example, the last three years in just such a misapplication. If this scenario is played out only 10% of the time on a $29 billion budget, the impact would be $2.9 billion. Disclosed embodiments are meant to address such errors and saving manufacturers involved a significant sum by effectively managing their trade agreements.

An additional detail that further complicates the management of trade agreements is the recent prolific growth of third party purchasing providers, for example, Group Purchasing Organizations (GPOs). In the United States, GPOs are entities created to leverage the purchasing power of a group of businesses to obtain discounts from vendors based on the collective buying power of the GPO members. Many GPOs are funded by administrative fees that are paid by the vendors that GPOs oversee. Some GPOs are funded by fees paid by the buying members. Some GPOs are funded by a combination of both of these methods. These fees can be set as a percentage of the purchase or set as an annual flat rate. Some GPOs set mandatory participation levels for their members, while others are completely voluntary. Members participate based on their purchasing needs and their level of confidence in what should be competitive pricing negotiated by their GPOs.

In the food service industry, foodservice GPOs focus exclusively on the foodservice marketplace, including food and food-related purchasing for multi-unit foodservice operators, contract negotiation and supply chain services. These contract negotiations are made with supplier/manufacturing agreements and purchasing contracts for poultry, fresh produce, frozen food products, fresh and frozen meats, candy and snacks, dairy and bakery, dry goods, disposables and beverages.

The recent proliferation of GPOs adds considerably to the complexity and expense of managing supply chain agreements for manufacturers as more and more GPOs are organized and demand trade-spend agreements for their constituent members. For these GPOs, as well as for operators and distributors in general, it can be challenging to gain access to available trade-spend agreements and the assurance that, once accessed, that the trade-spend agreements sourced are the best (most competitive) and that they are properly implemented and/or paid.

The implementation strategies for effective trade-spend program execution (actually delivering the negotiated performance goals) are at a crossroads. It is estimated that the large majority of trade-spend agreements will be conducted in the next ten years under some type of highly structured contract through some type of consolidated purchasing entity. This change will carry with it a profound implication of how trade-spend agreements are reached; thus, entities will need to shift from deal making deals to creating performance-based contracts, that are consistently monitored, and have a reward/penalty clause at settlement.

In moving to meet this new reality on the horizon, most manufacturers are unprepared because they lack a strong organizational competence for negotiation and contract management or fail to subscribe to contract standardization that streamlines negotiation, documentation, and monitoring processes. As part of this end-to-end processing, organizations will need to view their negotiation, management and monitoring from a “supply chain” perspective, which includes not only supply chain logistics, but also supply chain performance.

Thus, manufacturers must focus more on fulfillment consistent with contractual terms/expectations. Elimination of wasteful practices and building high performance at lower cost, the ability to enable customers to see their supply chain in real time—pull information and insight in real time—pull information and insight versus a push-out of information, perform demand forecasting and updates to assure dependability of supply and anticipate and respond appropriately to be socially responsible.

As the number of food related trade-spend agreements increases exponentially, the focus for foodservice supply chain organizations in meeting the challenge has largely, to this point, been to source and implement individual or one-off solutions like expensive back office software applications from SAP® and others. To the contrary, disclosed embodiments are based on a radically different holistic approach that eliminates the countless, thousands of duplicated and redundant processes in the sourcing, marketing and execution of trade agreements by delivering two outsourced business process management functions. These are an industry trade-spend agreement governance and clearinghouse system and methodologies and a foodservice consolidated purchasing e-commerce marketing and sourcing exchange service.

Disclosed embodiments are based on the belief that there aren't thousands of parties in the foodservice industry engaging in hundreds of thousands of food related trade-spend agreements; rather, there are thousands of parties unknowingly engaged in one type of food related trade-spend agreement process. Disclosed embodiments are also based on the recognition that it is neither cost effective nor efficient for the three major industry trade groups (i.e., operators, distributors or manufacturers) to individually source solutions for improving their own internal trade agreement management practices. Advances in cloud-based technologies capable of a virtually limitless number of complex data administration functions and financial settlement processes enable effective management of an infinite number of trade-spend agreements by a single specialized provider. Thus, an industry trade-spend agreement governance and clearinghouse system could effectively support the hundreds of thousands of food related trade-spend agreements in a single food related trade-spend agreement process.

Likewise, a food service consolidated purchasing e-commerce marketing and sourcing exchange service would address the thousands of consolidated purchasing entities seeking trade-spend agreements from vendors by providing vendor trade-spend agreements available for qualified consolidated purchasing entities to access. This will enable efficient and less expensive agreement marketing and sourcing by eliminating the need to source such agreements through the multitude of different channels including web sites or other more traditional methods.

In accordance with disclosed embodiments, these two basic services may be delivered via a cloud-based, articulated technology platform, so as to enable complete outsourcing of command and control of the full life cycle of trade-spend agreements as well as an e-commerce exchange for the marketing and sourcing of trade agreements. One trade agreement process management and delivery platform will replace thousands of individual trade agreement systems and processes with a single provider organization that is based upon standardized disciplines and processes.

Turning to the details of such disclosed embodiments, it should be understood that the fundamental elements common to all trade agreements may be considered the same or similar and, therefore, a single technology platform can be implemented to deliver optimal trade agreement performance for all parties to such agreements. The technology platform will provide the systems and processes necessary for trade agreement inception and governance, act as a clearinghouse for settlement of those trade agreements as well as provide an e-commerce exchange for the marketing and sourcing of trade agreements. The technology will cover all functional elements from both a “Buyer” and “Seller” perspective.

Embodiments disclosed herein are related to systems and methods for a technology platform for trade agreement life cycle management between and among participants in a supply chain. The technology exists in an open cloud-based platform with secure access at various levels of authentication via a web portal.

Consistent with some embodiments, there is provided, at the core of the technology platform, a data warehouse and database management platform. Database elements include trade agreements, trade agreement stakeholders (suppliers, distributors, and end users). Data is sourced from transactions within the supply chain and from industry third party aggregating sources. Data synchronization and standardization processes become established standards.

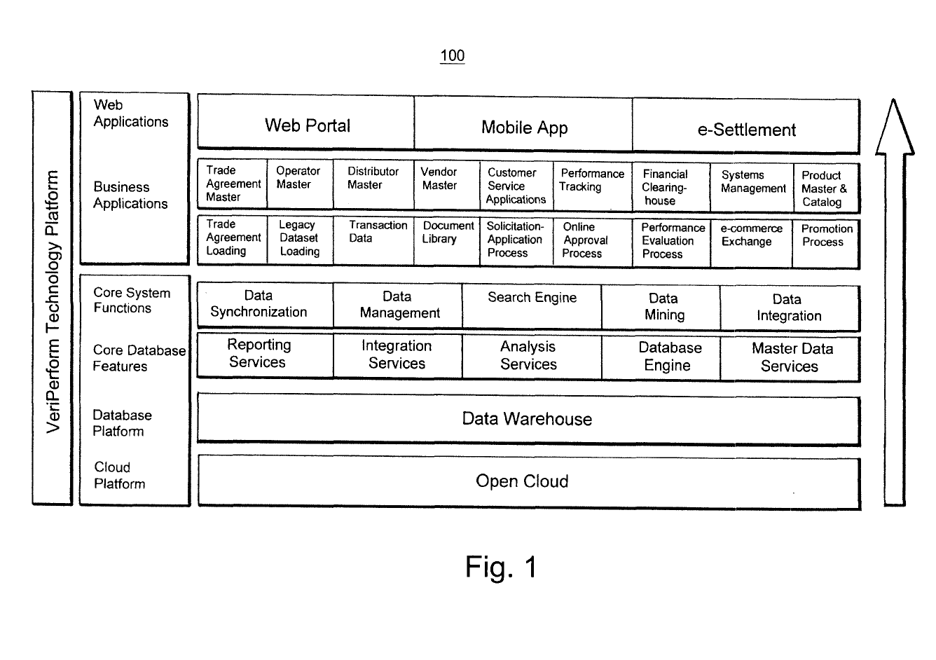

FIG. 1 is block diagram illustrating one embodiment of the system providing the technology platform including basic functional elements, consistent with some embodiments. System 100 may include an open cloud platform housing a data warehouse as well as suite of business analytics and management functional elements. Trade agreements may be loaded into the platform via an online negotiation/planning application over the Internet or an Intranet or directly from supply chain trading parties. In each case, the agreement may be standardized to meet established business rules and guidelines allowing for complete synchronization with all of the ensuing management actions to follow. This may involve analyzing and identifying the key terms of the agreements and mapping those key terms to specific fields of identified master traded agreement(s) and mapping the fields to processes for subsequent monitoring by the system.

In accordance with at least one disclosed embodiment, the technology platform may, of necessity, be a robust and intricately integrated platform that goes well beyond today's existing cloud-ready SQL Server 2012 data management system that administers, tracks, and analyzes a limited range of trade agreements. Thus, disclosed embodiments may provide a complete trade agreement lifecycle enterprise system and a functional e-commerce exchange application.

Master databases may be managed through a web based portal as shown in FIG. 1. In accordance with the platform illustrated in FIG. 1, an open cloud configuration is used in conjunction with data warehousing to support various core database features including reporting, integration, analysis and master data services along with a database engine. Accordingly, the platform enables data synchronization, data management, data mining, data integration and search engine functionality. This functionality enables various business applications as illustrated in FIG. 1, which may all be accessible via various web applications including a web portal, mobile application and e-settlement access points. With this configuration various capabilities are available, for example, product mapping, e.g., matching non-trade-spend agreement products with those that are on a trade-spend agreement, approval of new client operator locations via web based forms and maintaining master databases for all constituents, products and services.

Disclosed embodiments provide a complete inception to settlement trade agreement life cycle management service for foodservice trade-spend agreements in addition to a consolidated purchasing marketing and sourcing e-commerce exchange.

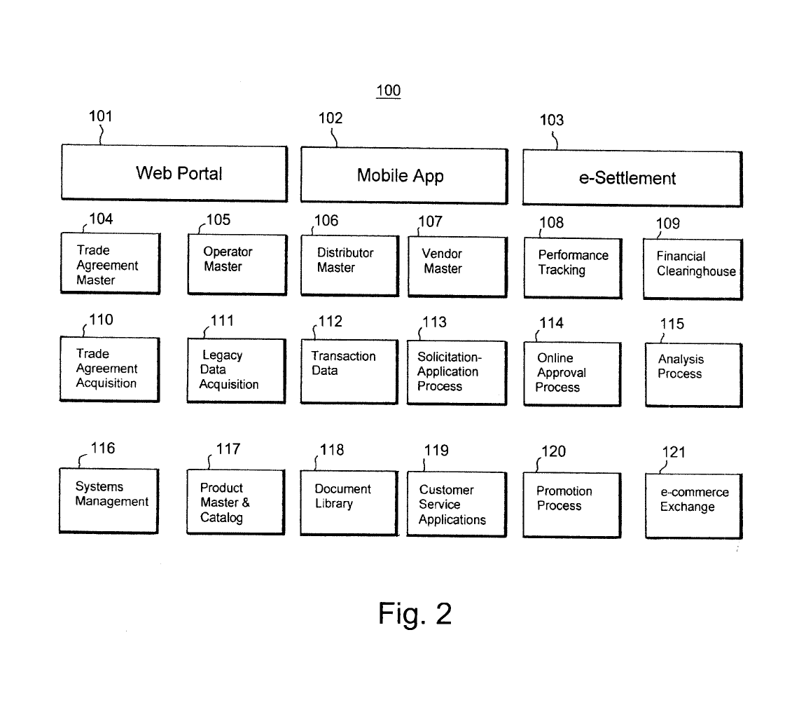

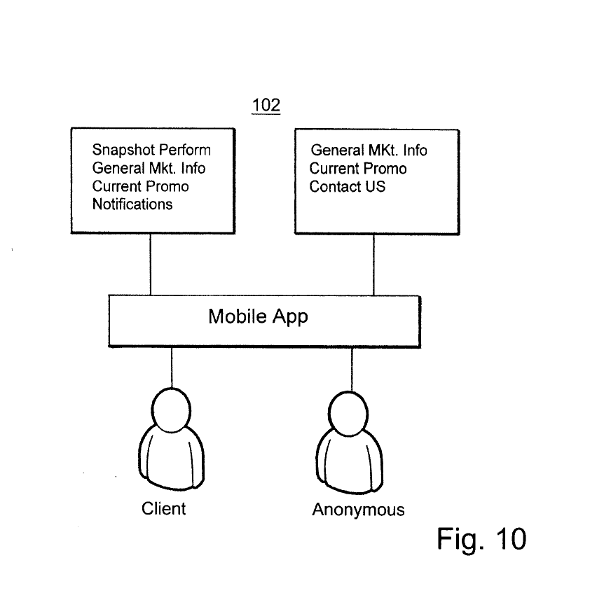

FIG. 2 shows and exploded view of some of the details of the disclosed embodiment illustrated in FIG. 1. As shown in FIG. 2, it should be understood that there are at least three external access points for various users of the system 100: web portal 101, mobile app(s) 102 (explained in more detail below in connection with FIG. 10), and e-Settlement access point 103. The web portal 101 may be used by stakeholders and system administration personnel to input data and manage stakeholders' trade agreement portfolios beginning with identifying a potential target supply chain partner, e.g., buyer or seller and ending with monitoring and evaluation of whether the supply chain partners have fulfilled key terms of a transacted and settled trade agreement. Likewise, some version or subset of the functionality provided by the web portal 101 will be provided by the mobile application 102 interacting with the system 100. The e-Settlement access point is a conduit that enables settlement of trade agreement financial commitments and/or obligations and interaction with the system 100 on the part of financial services and banking organizations.

As explained above, the system 100 enables various business applications including functionality for managing a master trade agreement database 104, master operator database 105, master distributor database 106, and master vendor database 107.

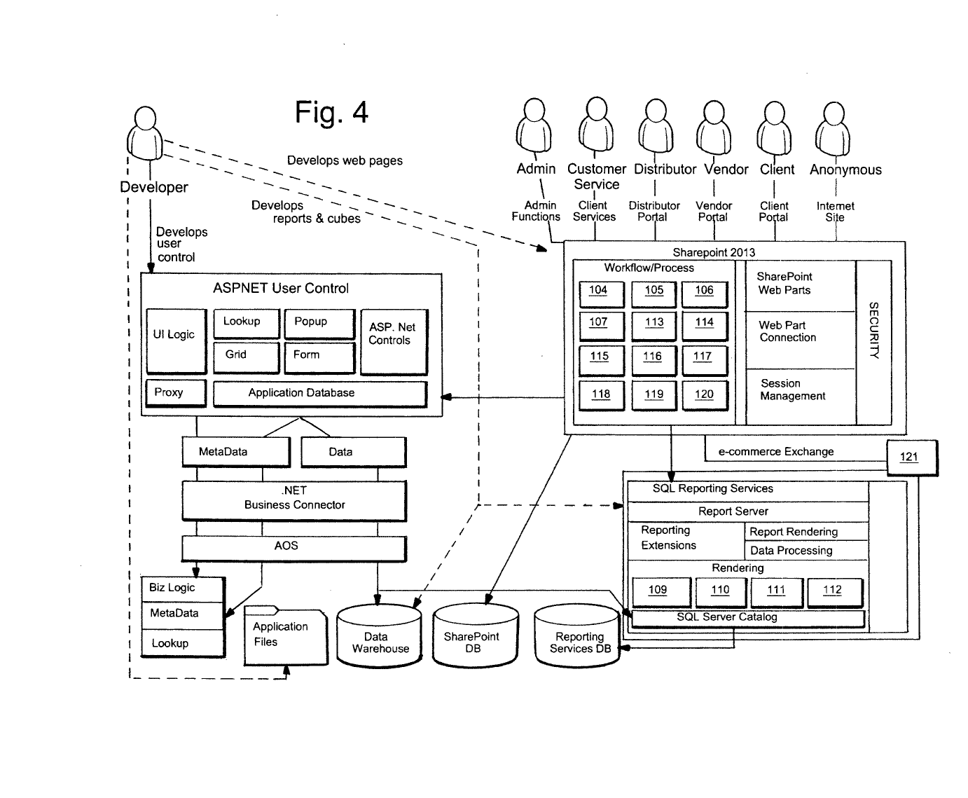

The master trade agreement database 104 includes all trade agreements for stakeholders and may be organized by the user. Within this database, the master trade agreements may be standardized to map to particular key metadata term sets to ensure that terminology is consistent facilitating ease of management and performance measurement. The master operator database 105 is a database that stores a listing of all the operators, e.g., Sonic®, Chile's® that have trade agreements managed within the system. FIG. 4 is flow diagram of the embodiment for building and maintaining the master databases via the online planning tool, and via direct communication from stakeholders 110 as well as sourcing available third party industry data 111 and transaction data secured from supply chain stakeholder/providers that enables the building of the trade agreement master database 104 product master database 105 vendor master database 108 operator master database 106 and distributor master database 107, which are integrated and combined into the technology platform for a variety of embodiments elsewhere in the process. The trade agreement master database 104 establishes the key performance requirements in a standard structure and format allowing for the active promotion 120, performance 108, settlement 109, and final evaluation of the trade agreement 115.

The operator master database 105 provides an established grouping of end-users of trade agreements that affords the sellers of the trade agreements protection against issuance of duplicate payouts on transactions, e.g., transactions to the end user ending up tracking to more than one distribution source. The operator maser database also provides trade agreement seller's access to the end user for promotions 120 and/or other solicitation 113, and other opportunities.

The product master database 117 places all products in a standardized catalog affording relational analysis and performance tracking 108. Mapping and matching of similar products provides for active engagement with stakeholders to drive optimal performance through the customer service application 120.

Similarly, the master distributor database 106 is a database that stores a listing of all the distributors, e.g., SYSCO®, U.S. Foods®, and Gordon Food Service® that have trade agreements managed within the system. The master vendor database 107 is a database that stores a listing of all the vendors, e.g., Heinz®, Hunt's® that have trade agreements managed within the system.

Disclosed embodiments may create, standardize, manage and map terms within the trade agreements and other document stored in the databases using term sets. This may be done utilizing metadata management features in Microsoft® SharePoint Server 2013 to provide support for the implementation of formal taxonomies through managed terms. Thus, terms may be created and managed in the Term Store Management Tool.

For example, SharePoint may be used to organize and manage documents stored in the databases through Managed Data. Managed metadata in SharePoint is a centralized approach to defining terms and enterprise keywords that can be used as metadata for the stored trade agreements and other documents. Terms (and term sets) are words (or groups of words) associated with metadata categories defined within the documents, restricting the values that can be entered for particular categories. Enterprise keywords are words or phrases added within a single category, but which aren't hierarchical like terms. Predefined keywords can be also be created.

This approach to standardization of terms within stored trade agreements enables consistent use of terminology so that terminology is used consistently across the organization regardless of department or group, site collection, site or library. This ensures data is accessible not only by people looking through the content, but also by search engines and other types of content queries. This approach also improves the ability to update metadata: You can update (add or edit) metadata in one location and have the change made across all site collections and libraries or lists where the metadata is used.

Terms, term sets and enterprise keywords can be defined within the scope of a collection of documents (e.g., for a particular supply chain partner) or they can be defined globally across your entire SharePoint environment. Term Stores are stored within a Managed Metadata service, which are each mapped to a web application and has a database that stores the term store. Thus, the e term store may be managed using the Term Store Management Tool. Within a term store, term store groups may be created, which are security groups that indicate who can have access to create and manage terms and term sets.

Thus, because most organizations, and to some extent industries, share common vocabulary that map to all the unstructured content that they produce and maintain, that taxonomy can be incorporated into the term management to provide standardization for organizations, supply chains or globally.

Additionally, performance tracking functionality may be provided using the performance tracking module 108 that enables effective tracking of performance of agreement terms for agreements being managed by the system 100. At 108, performance is tracked wherein the monitored performance is compared with the terms of specific trade agreements.

The system 100 also provides a financial clearinghouse module 109 supports settlement among the stakeholders at the end of the term of the trade agreement. Thus, the financial clearinghouse module 109 arranges for financial transaction(s) to fulfill terms of trade agreements.

A trade agreement acquisition processing module 110 enables the ability to build a trade agreement using the system's online tool and/or importing a stakeholder's trade agreement.

A legacy data acquisition process module 111 enables the ability to import any legacy data provided by a stakeholder that the stakeholder deems relevant to their trade agreements being managed by the system 100. Subsequently, this module 111 can also map the data (e.g., via a macro) to trade agreement data to ensure the data is accurate, complete and consistent.

Transaction data processing module 112 receives data from the stakeholders indicating transactions covered under the trade agreements for the stakeholders. For example, the processing module 112 receives notifications regarding purchase and shipment of product from one supply chain partner to another.

A solicitation application processing module 113 enables the system to, on behalf of a client stakeholder, approach other organizations that may be potential supply chain partners with solicitations to enter into one or more trade agreement(s) with the client stakeholder.

An online approval processing module 114 enables the system to approve organizations to enter into trade agreements with supply chain partners, e.g., in response to a solicitation or other opportunities.

An analysis process module 115 analyzes the specifics of trade agreements and goals or opportunity incentives to determine whether and to what extent the trade agreement parties have fulfilled their obligations under the trade agreement.

A systems management processing module 116 provides for overall operation of and development of the reports, functionality and modules used and supported by the system 100. Thus, his module supports administration of the system and its functionality, as discussed below in FIG. 4.

A product master and catalog storage database 117 is a database that stores a listing of all the products associated with trade agreements managed within the system. It may include any point of sale data and details pertaining to the products that are the subject of trade agreements, cut sheets, etc.

A document library database 118 serves to store PDF copies of necessary supporting documents that support the trade agreements managed by the system.

A customer service applications module 119 provides a dashboard type environment that enables administration personnel for the system to have access to agreement and performance data.

A promotion process module 120 supports promotion of trade agreements via email, facsimile transmission, text message, etc. Thus, the promotion process supports advertisement of various trade agreements available through and managed by the system 100.

An e-commerce exchange 121 enables a prospective client to settle transactions made under the trade agreement and automatically have that transaction data associated with the particular trade secret to which the transaction pertains.

The Product Catalog, 117, additionally contains Adobe cut-sheets and other media containing information regarding each product that is viewable online either as drill down information listed in trade agreement product listings or reports but also is available in the e-commerce Exchange, 121.

The e-commerce Exchange, 121, provides sellers to market their trade agreements to buyers either existing or potential. Thus, financial settlement methodologies may include an active credit/debit action whereby financial settlements among trade agreement stakeholders are afforded electronically.

The Vendor Database, 107, establishes a standardized profile of each vendor by product category, foodservice segment, and other unique identifiers such as brands, for a vendor. This affords for effective communication of potential sales opportunities and other embodiments.

The Distributor Master Database, 107, establishes a standardized catalog of distribution outlets for trade agreement products to end-user locations.

It should be understood that the various databases illustrated in FIG. 4 along with the Website and at least some portion of the software providing the admin functions, client services, distributor portal, vendor portal, client portal and Internet site may be running on one or more servers that are configured to communicate with trade agreement parties and administrative personnel via the above-described communication network(s).

The system 100 may be configured to store information in the illustrated databases which may be included in the computer readable memory and/or other data storage. Accordingly, the user interfaces illustrated in FIG. 2 (101-103) may be configured to enable input/output of data to interact with components of the system 100 as well as other systems coupled to the system 100. Accordingly, the user interfaces may be implemented as web-based user interfaces provided by software stored in memory or running on one or more servers associated with or supporting the system 100.

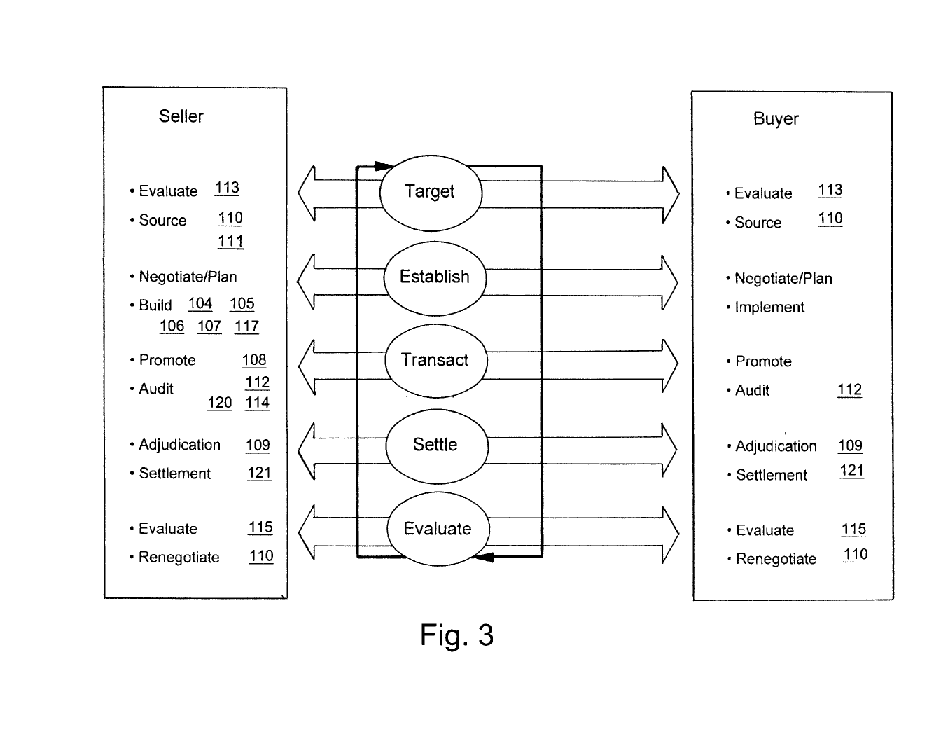

With these functional components in mind, turning to the FIG. 3, the disclosed embodiments are explained more fully in the context of a trade agreement lifecycle model with accompanying technology platform touchpoints in accordance with the disclosed embodiments. As shown in FIG. 3, during that lifecycle phase wherein sellers and buyers are attempting to identify one another, the solicitation-application processing module 113 works in coordination with functionality provided by the trade agreement acquisition module 110 and legacy data acquisition module 11 to obtain data for analysis to determine with whom and what trade agreements should be considered by the buyer or seller.

Likewise, during that life cycle phase for establishing a trade agreement, the negotiation, planning and building of the trade agreement from the seller side ma utilize the data stored in the master databases 104-107 as well as the product master and cat log database 117.

During the transaction phase, the transaction data processing module 112, performance tracking module 108, promotion processing 120 and online approval processing 114 may be utilized.

Further, during settlement, the financial clearinghouse 109 and e-commerce exchange 121 enables a prospective client to settle transactions made under the trade agreement and automatically have that transaction data associated with the particular trade secret to which the transaction pertains.

With this associated data mapped to the trade agreements along with performance tracking data, the supply chain partners are in a position to effectively evaluate the parties' performance under the trade agreement(s) and renegotiate if necessary.

FIG. 4 illustrates a high-level overview of the platform architecture, administration, function and web portal accessibility of various users including the system's administrative and customer service personnel, as well as representatives from the various stakeholders. Web portal access may be available for all user types including staff (administrators, customer service personnel, etc.) and stakeholders.

Additionally, FIG. 4 illustrates how a developer has the ability to reconfigure and build onto the system in a manner that allows changes to be rolled out through the system for generating new reports and interface screens available via portals and/or web site(s) and mobile applications supported by the platform 100.

It should be understood that the platform 100 may be accessed via one or more communication networks that may include any type of communications network including but not limited to the cellular or landline phone networks, the Internet, one or intranets (public or private), local area networks, such as Wireless Local Area Networks (WLAN), BlueTooth (BT), etc. The communication networks can also include any other type of network of interconnected devices or device networks, e.g., interconnected computers or computer networks. Accordingly, it should be understood that the communication networks can also be a combination of a plurality of different types of networks forming one or more hybrid networks.

It should be understood that each of the portals identified in FIG. 4 may be customized for particular types of stakeholders or individual stakeholders. Moreover, it should be understood that some functionality provided by the modules illustrated in FIGS. 2 and 4 may be available from third party providers. Accordingly, providers of these functional elements may be implemented, for example, as Microsoft® solutions or services including but not limited to Microsoft SQL 2012 or SharePoint 2013.

Analytical, evaluative and performance methodologies and system modules may provide trade agreement stakeholders with definitive data and other key informational elements post trade agreement.

Platform operations may be accessible to varying levels of users including master administration and client service staff for an organization providing the platform as well as clients and client customers. The security of the data will be of utmost importance.

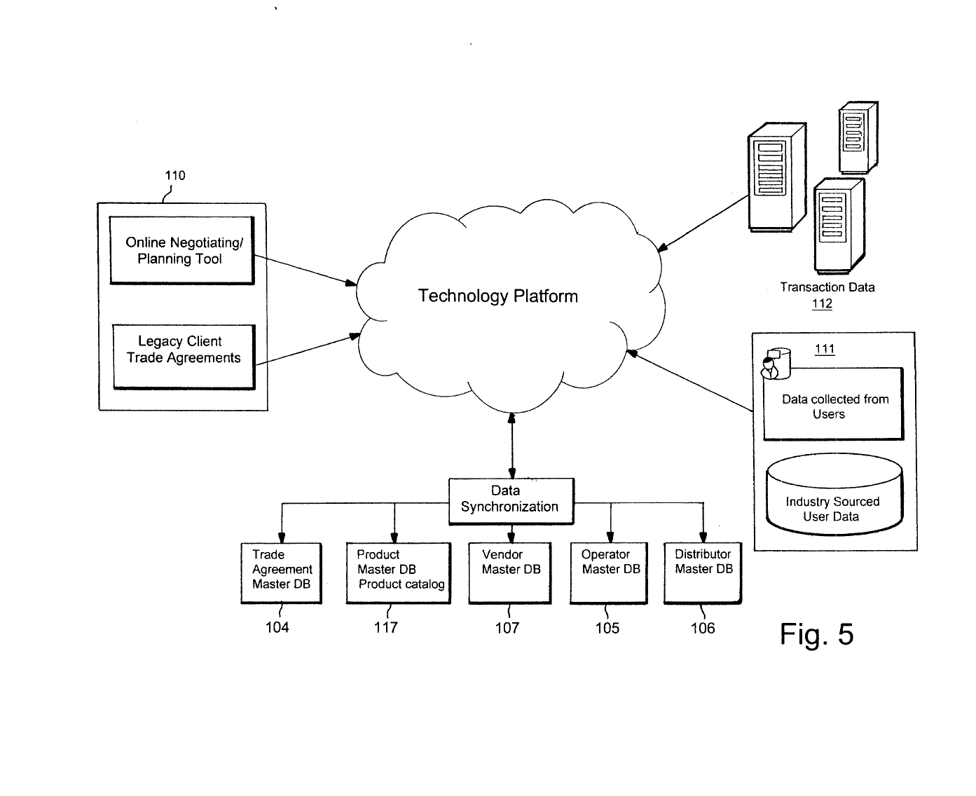

FIG. 5 is a figure illustrating onboarding and synchronization of client and industry sourced data and trade agreements consistent with at least one embodiment. As shown in FIG. 5, when da is collected from users using he legacy data acquisition module 11, it may be integrated with industry sourced user data available to the system 100. This data is integrated with transaction data generated by the transaction data processing module 112 discussed above and any trade agreement data generated by the trade agreement acquisition module 110 and synchronized to provide complete consistent data that is stored in the various databases 104-108 and 117.

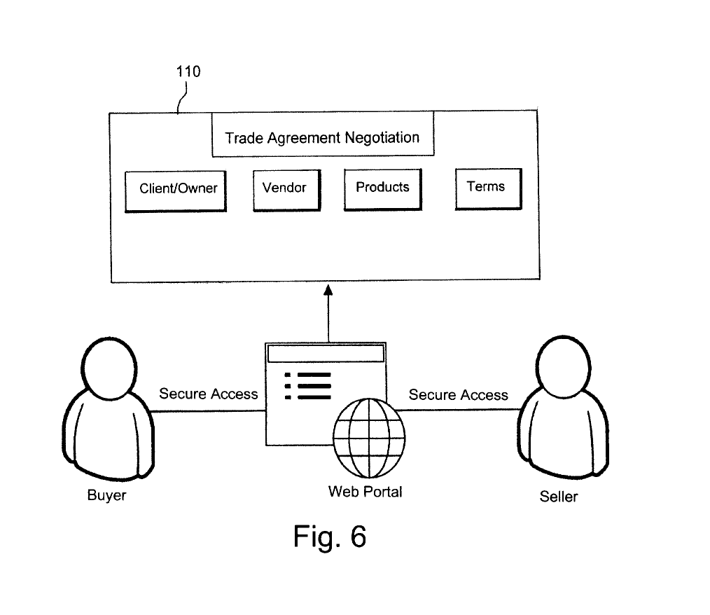

In this way, the data is consistently managed, accessed and monitored and trade agreements are correctly reviewed and used to set the key terms of transactions between the stakeholders. Thus, supply chain partners have the ability to negotiate, access and renegotiate key terms of trade agreements to effectively obtain the best position and ensure that the negotiated positions are being fulfilled. Therefore, as shown in FIG. 6, parties can enter into online negotiation/planning of trade agreements via a web portal or web site available via the system via the on-line negotiation planning tool provided by the trade agreement acquisition processing module 110. FIG. 6 is a flow diagram depicting the embodiment of two parties engaging in the online trade agreement negotiation application to reach agreement on the terms and other conditions for a final trade agreement between the parties. Within that trade agreement acquisition tool, parties, e.g., a buyer and seller can negotiate various terms of a trade agreement as well as the client/owner, vendor and products covered under the agreement.

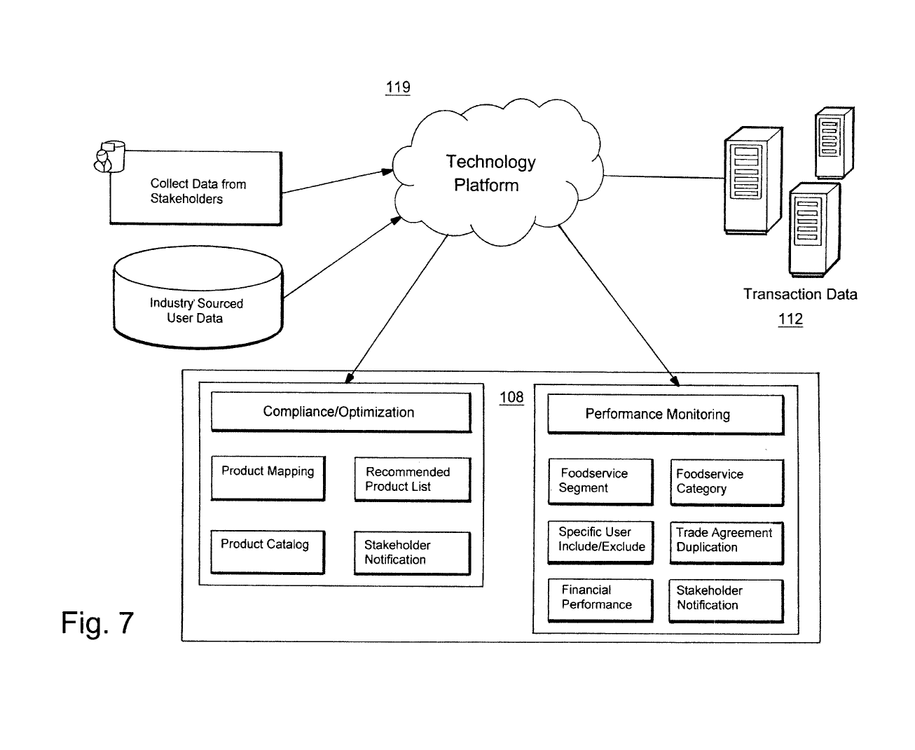

Thus, functionality for trade agreement lifecycle management may be established in a customized and scalable Microsoft® Business Management Analytics Platform. Once trade agreements are loaded, the functional elements and measurable Key Performance Indicators (KPI's) may be established within the Business Management Platform. Methodologies and system modules for delivering trade agreement performance may be driven from this platform, as shown in FIG. 7.

Measurement and Proof of Performance methodologies and system modules may provide ongoing monitoring of individual trade agreement performance and a customized reporting and notification system to provide actionable information directly to key stakeholders. Thus, as illustrated in FIG. 7 active monitoring of trade agreement performance may be performed using the system to provide accurate, complete and consistent customer service. This may drive increased compliance with trade agreements. Thus, as shown in FIG. 7, in the context of customer service 119, data is collected from users along with industry sourced user data and it is used to generate interactions with stakeholders and potential stakeholders via the performance tracking module 108. This is done by driving compliance and optimization under pertinent trade agreements by sending information to trade agreement parties regarding product mapping, recommended product lists, product catalogs and access links to such catalogs via stakeholder notification messages, e.g., email, facsimile messages, text messages, etc.,

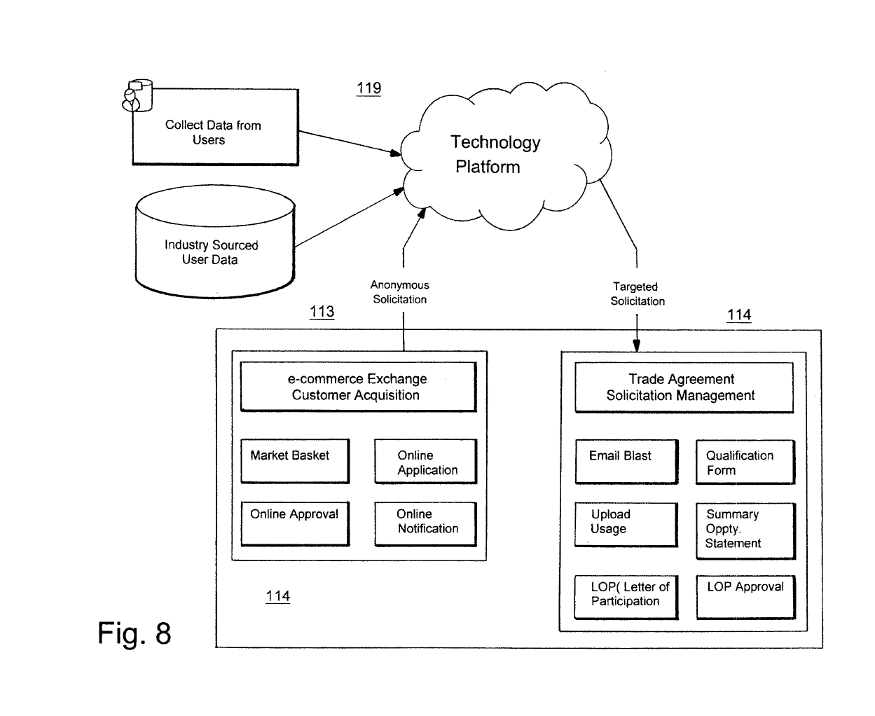

Likewise, promotional/compliance methodologies and system modules may include providing an online e-commerce exchange for trade agreement products or services. Qualified users may be able to access detailed product information including cut-sheets and videos of trade agreement products. Optionally, a solicitation process methodology and system module may be incorporated or utilized whereby prospective buyers are vetted, qualified, approved and certified to participate in trade agreement(s). Thus, as illustrated in FIG. 8 the system may be utilized to perform active promotion of trade agreements and solicitation of new trade agreement customers. Thus, as shown in FIG. 8, in the context of customer service 119, data is collected from users along with industry sourced user data and it is used to generate interactions with stakeholders and potential stakeholders via solicitation/application processing 113 and online approval processing 114. Therefore, the technology platform can process incoming solicitations including via e-commerce exchange processing including market basket processing and online application, approval and notification. Additionally, the platform can support targeted solicitation processing and management via email blasts, uploaded usage, the use of qualification forms, summary opportunity statements letters of participation and LOP approval.

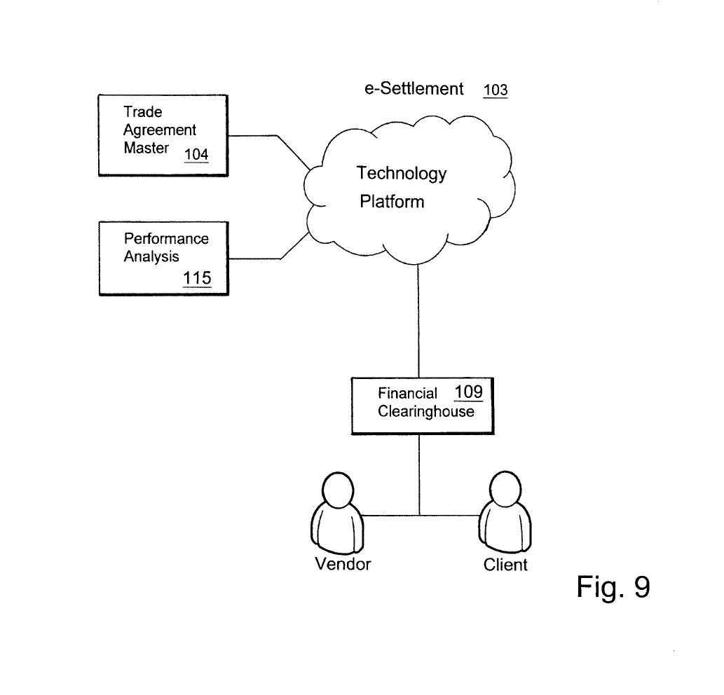

FIG. 9 is a figure illustrating the adjudication and financial settlement of trade agreements. As shown in FIG. 9, the technology platform may utilize both the trade agreement master database 115 and access performance analysis processing 115 to support interaction between two parties to a trade agreement, e.g., a vendor and a client (e.g., operator, or other stakeholder) an settlement of a transaction using the financial clearinghouse module 109 via interaction with financial and banking organizations to facilitate payment.

FIG. 10 is a figure illustrating the use of the mobile application 102 referred to above. As shown in FIG. 10, the mobile application may be downloaded to a mobile device to provide to a stakeholder or client various pieces of relevant information including snapshot information, performance information pertaining to one or more trade agreements being managed by the system, general marketing information, current promotion notifications, etc. Likewise, the mobile app may be downloaded to a mobile device by someone other than a stakeholder with current trade agreements being managed by the system to provide general marketing information, current promotional information and contact information. It should be understood that the mobile app may be downloaded to and run on various mobile devices, including tablet computers, smart phone, mobile phone, lap top, PDA, multimedia computer, etc. Accordingly, although not illustrated, it should be understood that these devices may include a processor connected to a user interface, computer readable memory and/or other data storage and a display and/or other output device.

It should also be understood that the functionality described herein for the system 100 may be implemented using one or more modules to manage, access and store data in a plurality of databases to facilitate trade agreement management. Therefore, it should be understood that each of the functionality modules disclosed herein may be implemented using computer executable instructions and data accessed and used by one or more processors, potentially running on one or more servers to implement the system disclosed herein. The computer executable instructions may be stored in memory that may be implemented with any combination of read only memory modules or random access memory modules, optionally including both volatile and nonvolatile memory that may include many databases that separately include the data described above.

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Thus it should be understood that the utility of the presently disclosed embodiments has been explained in conjunction with food service related trade agreements; however, the disclosed embodiments may be implemented and used to promote, initiate, and negotiate trade agreements for other types of products and services; additionally, the disclosed embodiments may be utilized to initiate or monitor transactions, transaction performance and transaction settlement for transactions covered under such trade agreements and, if necessary the renegotiation of such trade agreements.

Various changes may be made without departing from the spirit and scope of the invention.

Although certain embodiments have been described and illustrated in exemplary forms with a certain degree of particularity, it is noted that the description and illustrations have been made by way of example only. Numerous changes in the details of construction, combination, and arrangement of parts and operations may be made. Accordingly, such changes are intended to be included within the scope of the disclosure, the protected scope of which is defined by the claims.

We claim:

1. A system providing a technology platform that enables trade agreement life cycle management between and among participants in a supply chain, the system comprising:
at least one server coupled to at least one database, the a least one database including a data warehouse and database management platform;
the at least one database including trade agreements data and trade agreement supply chain participant data including data generated by and pertaining to transactions within the supply chain and from industry third party aggregating sources;
a web portal coupled to that at least one server that receives data input by the supply chain participants including trade agreement data; and
an online negotiation/planning application running on the at least one server that generates the data stored in the database based on data input into the web portal,
wherein, the system monitors the performance of trade governed by trade agreements loaded via the online negotiation/planning application or directly from supply chain participants, and
wherein the system promotes, initiates, and provides online tools for negotiation of trade agreements as well as supports initiation and monitoring of transactions, transaction performance and transaction settlement for transactions covered under such trade agreements and renegotiation of such trade agreements and generates and outputs notifications to the supply chain partners via the web portal regarding the monitored performance.

2. The system of claim 1, wherein the trade agreements include trade-spend agreements.

3. The system of claim 1, wherein the trade agreements are food service trade agreements.

4. The system of claim 1, wherein the food service trade agreement involve, as at least one participant healthcare, fast food, lodging, higher education, K-12 schools.

5. The system of claim 1, wherein the web portal in combination with the at least one server and the at least one database provide a consolidated purchasing e-commerce marketing and sourcing exchange service for use by consolidated purchasing entities seeking trade-spend agreements from vendors by providing vendor trade-spend agreements available for qualified consolidated purchasing entities to access.

6. The system of claim 1, wherein the trade-spend agreements include supplier/manufacturing agreements and purchasing contracts for poultry, fresh produce, frozen food products, fresh and frozen meats, candy and snacks, dairy and bakery, dry goods, disposables and beverages.

7. The system of claim 1, wherein the trade agreements include performance-based contracts that are monitored by the system, and have a reward/penalty clause at settlement.

8. The system of claim 1, wherein the at least one server is coupled to an e-Settlement portal that is configured to communicate with financial and banking institutions to settle payment for trade agreements managed by the system.

9. The system of claim 1, wherein the at least one database includes at least one database including master trade agreements used by the online negotiation/planning application system to facilitate trade agreement negotiation and acquisition.

10. The system of claim 1, wherein the web portal coupled to that at least one server that receives data input by the supply chain participants including trade agreement data receives data from the supply chain participants via a communication network coupled to the at least one server.

11. A method for providing a technology platform that enables trade agreement life cycle management between and among participants in a supply chain, the method comprising:
storing, at at least one database, trade agreements data and trade agreement supply chain participant data including data generated by and pertaining to transactions within the supply chain and from industry third party aggregating sources;
running computer executable instructions to promote and support initiation of trade agreements, and provide online tools for negotiation of trade agreements as well as support initiation and monitoring of transactions, transaction performance and transaction settlement for transactions covered under such trade agreements and renegotiation of such trade agreements;
providing a web portal coupled to that at least one server that receives data input by the supply chain participants including trade agreement data;
generating, using an online negotiation/planning application running on the at least one server, data stored in the database based on data input into the web portal;
monitoring the performance of trade governed by trade agreements loaded via the online negotiation/planning application or directly from supply chain participants; and
generating and outputting notifications to the supply chain partners via the web portal regarding the monitored performance.

12. The method of claim 11, wherein the trade agreements include trade-spend agreements.

13. The method of claim 11, wherein the trade agreements are food service trade agreements.

14. The method of claim 11, wherein the food service trade agreement involve, as at least one participant healthcare, fast food, lodging, higher education, K-12 schools.

15. The method of claim 11, wherein the web portal in combination with the at least one server and the at least one database provide a consolidated purchasing e-commerce marketing and sourcing exchange service for use by consolidated purchasing entities seeking trade-spend agreements from vendors by providing vendor trade-spend agreements available for qualified consolidated purchasing entities to access.

16. The method of claim 11, wherein the trade-spend agreements include supplier/manufacturing agreements and purchasing contracts for poultry, fresh produce, frozen food products, fresh and frozen meats, candy and snacks, dairy and bakery, dry goods, disposables and beverages.

17. The method of claim 11, wherein the trade agreements include performance-based contracts that are monitored by the system, and have a reward/penalty clause at settlement.

18. The method of claim 11, wherein the at least one server is coupled to an e-Settlement portal that is configured to communicate with financial and banking institutions to settle payment for trade agreements managed by the system.

19. The method of claim 11, wherein the at least one database includes at least one database including master trade agreements used by the online negotiation/planning application system to facilitate trade agreement negotiation and acquisition.

20. The method of claim 11, wherein the web portal coupled to that at least one server that receives data input by the supply chain participants including trade agreement data receives data from the supply chain participants via a communication network coupled to the at least one server.
